(19) United States
(12) Patent Application Publication
(10) Pub. No.: US 2012/0254648 A1
(43) Pub. Date: Oct. 4, 2012

(54) PROGRAM PROCESSING APPARATUS

(75) Inventor: Seiji Hashimoto, Nishinomiya-shi (JP)

(73) Assignee: SANYO Electric Co., Ltd., Osaka (JP)

(21) Appl. No.: 13/434,577

(22) Filed: Mar. 29, 2012

(30) Foreign Application Priority Data
Mar. 29, 2011 (JP) 2011-71743

(51) Int. Cl. G06F 1/26; G06F 1/32

(52) U.S. Cl. 713/324; 713/300

(57) ABSTRACT

A program processing apparatus includes a detector. A detector detects a motion of a device. A first supplier supplies power to an internal memory in response to a detection of the detector. A loader loads a program executed by a processor into the internal memory, in association with a supplying process of the first supplier. A second supplier supplies the power to the processor in response to a power-on operation after a loading process of the loader.

### CROSS REFERENCE OF RELATED APPLICATION

The disclosure of Japanese Patent Application No. 2011-71743, which was filed on Mar. 29, 2011, is incorporated here by reference.

### BACKGROUND OF THE INVENTION

1. Field of the Invention

The present invention relates to a program processing apparatus. More particularly, the present invention relates to a program processing apparatus in which a program is executed by a processor.

2. Description of the Related Art

According to one example of this type of processing apparatus, an electronic device is configured by an emergency activation section and a continuous activation section. The emergency activation section is provided with a CPU (a center arithmetic processing device), a program storing memory, a main storing device, an operating section and a start-up time instructing section. The continuous activation section is provided with a timer, a start-up preparation instructing section and a start-up time memory. The start-up preparation instructing section transmits a start-up preparation instruction to a remote control receiving section, based on an output signal of a sensor composed of a gyro sensor, etc., which detects an angle speed. The remote control receiving section receives the start-up preparation instruction transmitted from the start-up preparation instructing section so as to apply the start-up preparation instruction to the CPU. When the start-up preparation instruction is received, the remote control receiving section applies the start-up preparation instruction to the CPU. Thereby, the emergency activation section is powered on, and the CPU executes a start-up preparation. In the start-up preparation, a part or all of following performances are included: a performance of expanding a program stored and compressed in the program storing memory, a performance of transferring the program stored in the program storing memory to the main storing device and a performance of executing a part of the program by the CPU.

However, in the above-described apparatus, the emergency activation section is powered on when the start-up preparation instruction is applied, and therefore, there is a possibility that power is supplied to all of composition elements of the emergency activation section such as the CPU, etc. Thereby, the power may be wasted resulting from the emergency activation section being unnecessarily started up if a period until the program becomes capable of being executed by the CPU is tried to be shortened.

### SUMMARY OF THE INVENTION

A program processing apparatus according to the present invention, comprises: a detector which detects a behavior of a device; a first supplier which supplies power to an internal memory in response to a detection of the detector; a loader which loads a program executed by a processor into the internal memory, in association with a supplying process of the first supplier; and a second supplier which supplies the power to the processor in response to a power-on operation after a loading process of the loader.

According to the present invention, a program processing program recorded on a non-transitory recording medium in order to control a program processing apparatus, the program causing a first processor of the program processing apparatus provided with a detector which detects a behavior of a device to perform the steps comprises: a first supplying step of supplying power to an internal memory in response to a detection of the detector; a loading step of loading a program executed by a processor into the internal memory, in association with a supplying process of the first supplying step; and a second supplying step of supplying the power to the processor in response to a power-on operation after a loading process of the loading step.

According to the present invention, a program processing method executed by a program processing apparatus provided with a detector which detects a behavior of a device, comprises: a first supplying step of supplying power to an internal memory in response to a detection of the detector; a loading step of loading a program executed by a processor into the internal memory, in association with a supplying process of the first supplying step; and a second supplying step of supplying the power to the processor in response to a power-on operation after a loading process of the loading step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a configuration of a register referred to by a sub CPU;

FIG. 4 (A) is a timing chart showing one portion of behavior in the embodiment shown in FIG. 2;

FIG. 4 (B) is a timing chart showing another portion of behavior in the embodiment shown in FIG. 2;

FIG. 5 (A) is a timing chart showing still another portion of behavior in the embodiment shown in FIG. 2;

FIG. 5 (B) is a timing chart showing yet another portion of behavior in the embodiment shown in FIG. 2;

FIG. 6 (A) is a timing chart showing another portion of behavior in the embodiment shown in FIG. 2;

FIG. 6 (B) is a timing chart showing still another portion of behavior in the embodiment shown in FIG. 2;

FIG. 7 is a flowchart showing one portion of behavior of the sub CPU applied to the embodiment shown in FIG. 2;

FIG. 8 is a flowchart showing another portion of behavior of the sub CPU applied to the embodiment shown in FIG. 2;

FIG. 9 is a flowchart showing still another portion of behavior of the sub CPU applied to the embodiment shown in FIG. 2;

FIG. 10 is a flowchart showing yet another portion of behavior of the sub CPU applied to the embodiment shown in FIG. 2;

FIG. 11 is a flowchart showing another portion of behavior of the sub CPU applied to the embodiment shown in FIG. 2; and

FIG. 12 is a flowchart showing one portion of behavior of a CPU applied to the embodiment in FIG. 2.

### DETAILED DESCRIPTION OF THE PREFERRED EMBODIMENTS

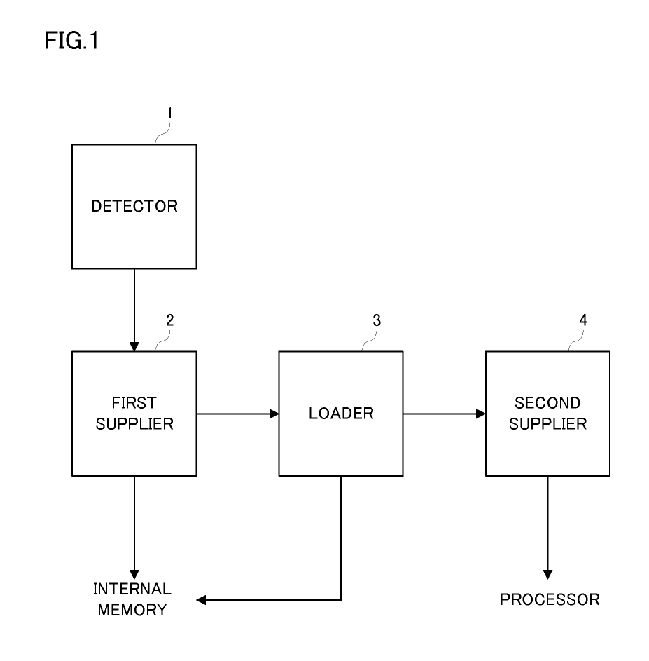

With reference to FIG. 1, a program processing apparatus according to one embodiment of the present invention is basically configured as follows: A detector 1 detects a motion of a device. A first supplier 2 supplies power to an internal memory in response to a detection of the detector 1. A loader 3 loads a program executed by a processor into the internal memory, in association with a supplying process of the first supplier 2. A second supplier 4 supplies the power to the processor in response to a power-on operation after a loading process of the loader 3.

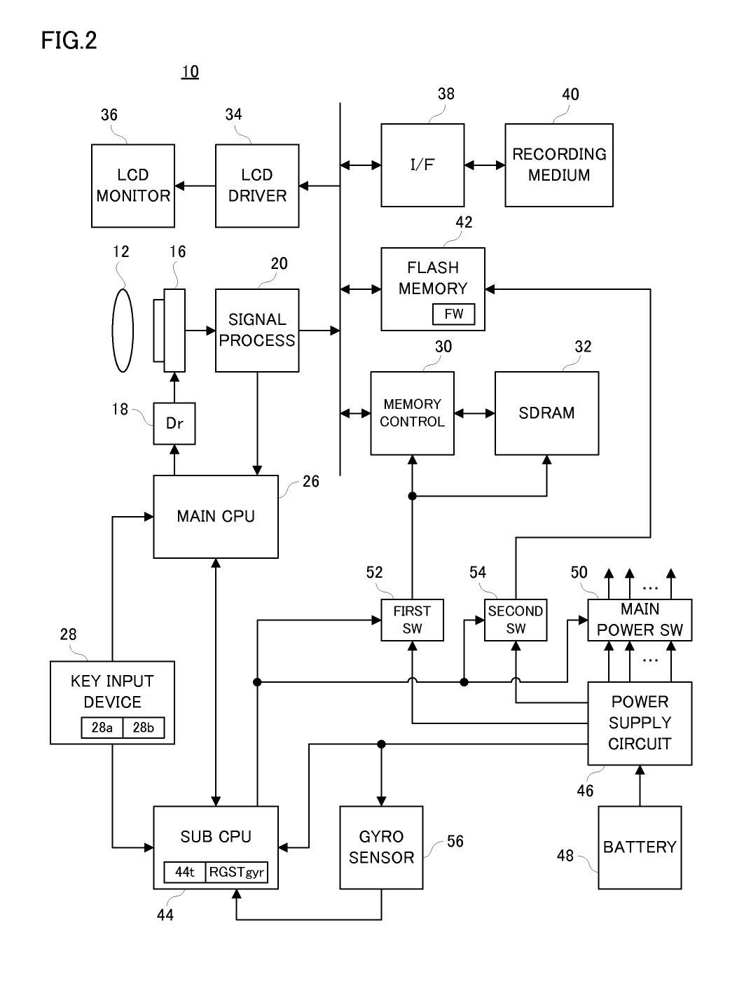

When the motion of the device is detected, the power is supplied to the internal memory, and concurrently, the program is loaded into the internal memory. Moreover, the power is supplied to the processor which executes the loaded program in response to the power-on operation after the loading process. Thus, it is not necessary to load the program when the program is thereafter executed by the processor, and as a result, it becomes possible to shorten a period until the program becomes capable of being executed. Moreover, it becomes possible to inhibit a waste of power resulting from the program processing apparatus being unnecessarily activated. With reference to FIG. 2, a digital camera 10 according to one embodiment includes a power supply circuit 46. The power supply circuit 46 generates a plurality of direct current power supplies, each of which shows a different voltage value, based on a battery 48.

One portion of the plurality of generated direct current power supplies is directly applied to a sub CPU 44 and a gyro sensor 56, and another portion of the plurality of generated direct current power supplies is applied to the entire system via a main power switch 50, a first memory power switch 52 and a second memory power switch 54. Therefore, the sub CPU 44 and the gyro sensor 56 are activated all the times, whereas elements configuring the entire system are controlled to be activated/stopped. In the entire system, a memory control circuit 30 and an SDRAM 32 are activated/stopped in response to turning on/off of the first memory power switch 52, and a flash memory 42 is activated/stopped in response to turning on/off of the second memory power switch 54. Another elements configuring the entire system are activated/stopped in response to turning on/off of the main power switch 50.

The flash memory 42 holds firmware of the digital camera 10 and an initial setting value necessary for executing the firmware.

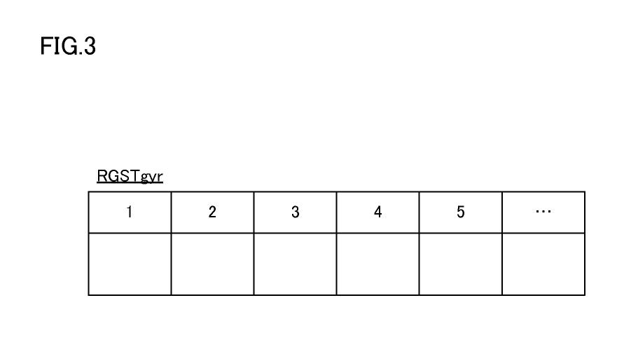

The gyro sensor 56 senses whether or not a motion has occurred in the digital camera 10, and outputs a motion vector representing the sensed motion when an occurrence of the motion is sensed. The motion vector outputted from the gyro sensor 56 is taken by the sub CPU 44 so as to be registered in a register RGSTgyr shown in FIG. 3. In the register RGSTgyr, a plurality of motion vectors respectively corresponding to multiple occurrences of the motions are held. It is noted that, a vibration, a movement, a rotation, a revolution, and etc. are contained in the motion sensed by the gyro sensor 56.

Generally, an operator of the digital camera 10 performs a power-on operation taking the digital camera 10 in his hand. Thus, when the motion vector is outputted from the gyro sensor 56, it is determined that the digital camera 10 is moved by the operator for the power-on operation. At this time, the sub CPU 44 controls the first memory power switch 52 and the second memory power switch 54 so as to activate the memory control circuit 30, the SDRAM 32 and the flash memory 42.

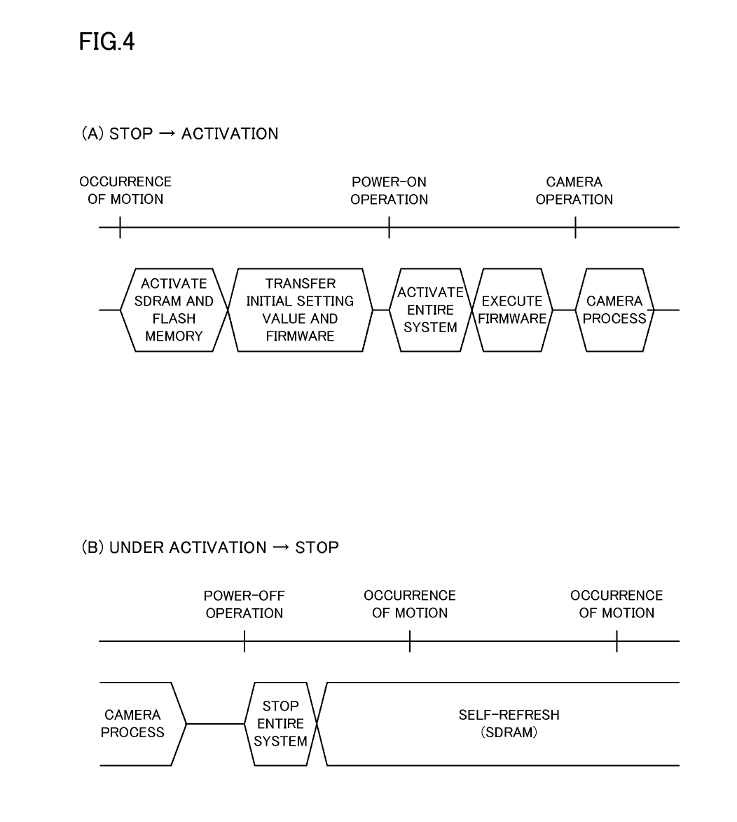

Subsequently, the sub CPU 44 transfers the firmware of the digital camera 10 and the initial setting value necessary for executing the firmware from the flash memory 42 to the SDRAM 32 (see FIG. 4 (A)). Upon completion of transferring, the sub CPU 44 executes resetting and starting a timer 44t A timer value is set to five seconds, for example.

When the power-on operation is performed by a power button 28a on a key input device 28 before time-out is occurred in the timer 44t, the sub CPU 44 activates remaining elements of the entire system having been inactivated by controlling the main power switch 50. The activated main CPU 26 executes the firmware held in the SDRAM 32.

It is noted that, when the power-on operation is performed without the digital camera 10 being moved, the motion vector is not outputted from the gyro sensor 56, and therefore, the above-described transferring process is not executed before the power-on operation. In this case, the sub CPU 44 transfers the firmware of the digital camera 10 and the initial setting value necessary for executing the firmware from the flash memory 42 to the SDRAM 32, after the entire system including the SDRAM 32 and the flash memory 42 is activated. The firmware thus held in the SDRAM 32 is executed by the activated main CPU 26.

When the firmware is executed, a main task is activated in the main CPU 26. Under the activated main task, the CPU 26 determines a state of a mode changing button 28md arranged in the key input device 28 (i.e., an operation mode at a current time point) so as to activate an imaging task corresponding to an imaging mode whereas activate a reproducing task corresponding to a reproducing mode.

When the imaging task is activated, the main CPU 26 activates a driver 18 for a moving-image taking process. In response to a vertical synchronization signal Vsync periodically generated, the driver 18 exposes an imaging surface and reads out electric charges produced on the imaging surface in a raster scanning manner. From an image sensor 16, raw image data representing a scene is repeatedly outputted.

A signal processing circuit 20 performs processes, such as white balance adjustment, color separation, and YUV conversion, on the raw image data outputted from the image sensor 16, and writes YUV formatted-image data created thereby into the SDRAM 32 through the memory control circuit 30. An LCD driver 34 reads out the image data stored in the SDRAM 32 through the memory control circuit 30 so as to drive an LCD monitor 36 based on the read-out image data. As a result, a real-time moving image of the scene (a live view image) is displayed on the LCD monitor 36.

When a shutter button 28sh is fully depressed, under the imaging task, the main CPU 26 executes a still-image taking process and a recording process. One frame of image data taken by the still-image taking process is recorded by an I/F 38 activated in association with the recording process, on a recording medium 40 in a file format.

When the reproducing task is activated, the CPU 26 designates the latest image file recorded in the recording medium 40 under the reproducing task as a reproduced image file so as to execute a reproducing process in which a designated image file is noticed. As a result, an optical image corresponding to image data of the designated image file is displayed on the LCD monitor 36.

By the operator operating the key input device 28, the main CPU 26 designates a succeeding image file or a preceding image file as a reproduced image file. The designated image file is subjected to the reproducing process similar to that described above, and as a result, a display of the LCD monitor 36 is updated.

With reference to FIG. 4 (B), when a power-off operation is performed by the power button 28a, the main CPU 26 ends tasks being under execution and issues a self-refresh command to the SDRAM 32. The SDRAM 32 starts to execute a refresh using own internal counter. A part of the entire system except the memory control circuit 30 and the SDRAM 32 is stopped according to a control of the main power switch 50 and the second memory power switch 54 by the sub CPU 44.

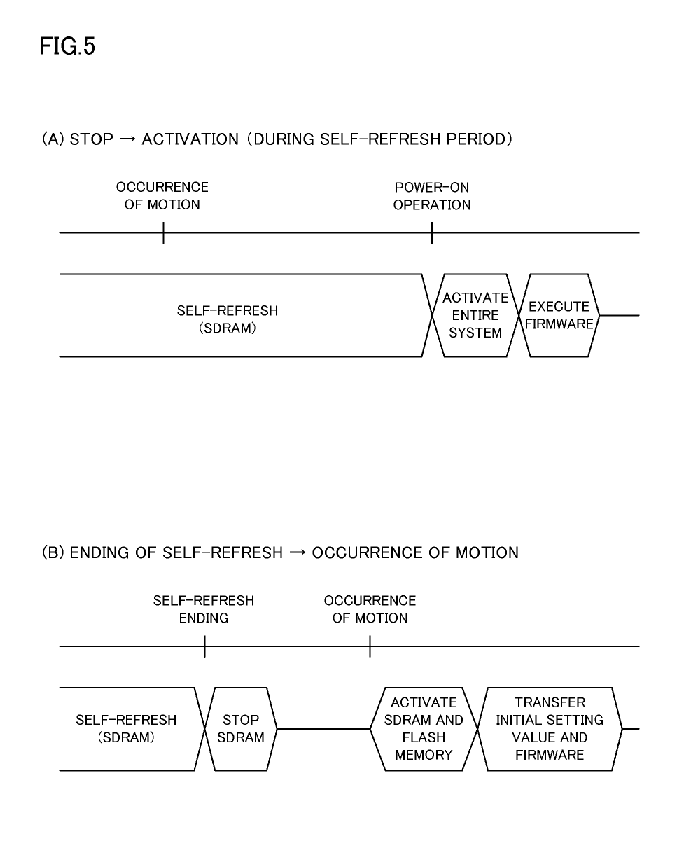

The self-refresh by the SDRAM 32 is repeatedly executed during a predetermined period. The predetermined period is set to an hour, for example. During a period of executing the self-refresh, the firmware and the initial setting value necessary for executing the firmware are held in the SDRAM 32. Thus, when the motion vector is outputted from the gyro sensor 56 during the period of executing the self-refresh of the SDRAM 32, the sub CPU 44 does not execute the above-described transferring process (see FIG. 4 (B)). Moreover, with reference to FIG. 5 (A), when the power-on operation is performed by the power button 28a during the period of executing the self-refresh of the SDRAM 32, without the above-described transferring process being execute, the remaining elements of the entire system having been inactivated are activated and the firmware is executed in the main CPU 26.

With reference to FIG. 5 (B), when the period of executing the self-refresh of the SDRAM 32 is ended, the sub CPU 44 stops the memory control circuit 30 and the SDRAM 32 by controlling the first memory power switch 52. When the SDRAM 32 is stopped, the firmware and the initial setting value necessary for executing the firmware disappear from the SDRAM 32. Thus, when the motion vector is outputted from the gyro sensor 56 after the period of executing the self-refresh of the SDRAM 32 is ended, as described above, the sub CPU 44 activates the SDRAM 32 and the flash memory 42. Subsequently, the sub CPU 44 transfers the firmware and the initial setting value necessary for executing the firmware from the flash memory 42 to the SDRAM 32 so as to execute resetting and starting the timer 44t. When the power-on operation is performed by the power button 28a on the key input device 28 before the time-out is occurred in the timer 44t, the remaining elements of the entire system having been inactivated are activated and the firmware is executed in the main CPU 26 (see FIG. 4 (A)).

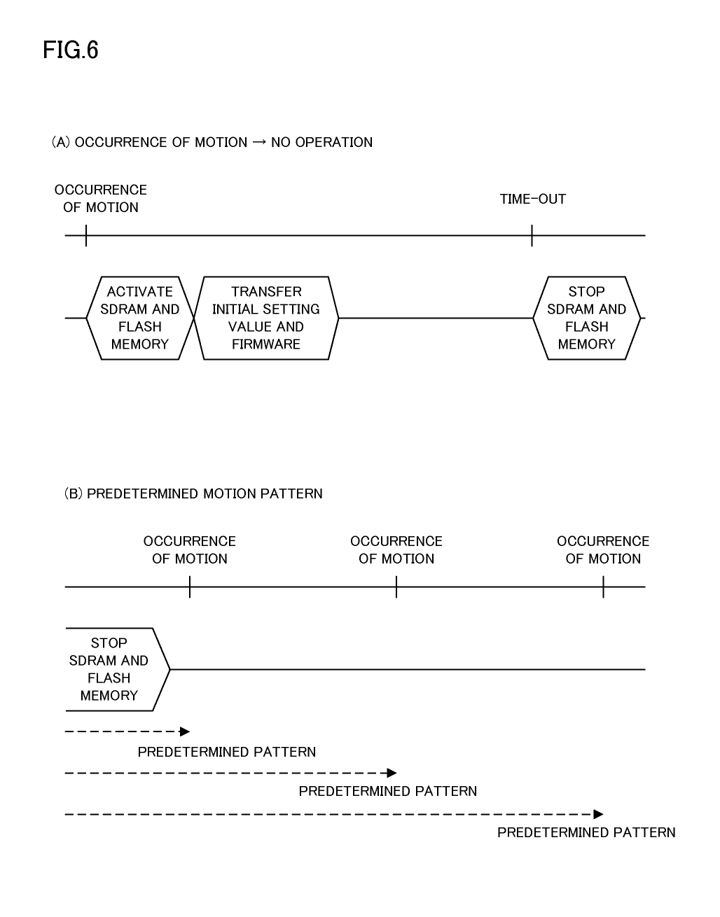

When the time-out is occurred in the timer 44t without the power-on operation being performed by the power button 28a, it is determined that the motion of the digital camera 10 sensed by the gyro sensor 56 is not for the power-on operation. Accordingly, the sub CPU 44 controls the first memory power switch 52 and the second memory power switch 54 so as to stop the memory control circuit 30, the SDRAM 32 and the flash memory 42 (see FIG. 6 (A)).

Thus, irrespective of whether or not the power-on operation is performed, the motion vector is outputted from the gyro sensor 56 according to the occurrence of the motion of the digital camera 10. For example, when the digital camera 10 is carried by the operator, according to an occurrence of a vibration repeated resulting from transportation by a vehicle, a walk of the operator and etc., the gyro sensor 56 outputs the motion vector at every time the motion of the digital camera 10 is sensed. An output pattern of the motion vector resulting from the periodical vibration is prepared as one or at least two predetermined motion patterns.

When a motion vector is newly registered in the register RGSTgyr, the sub CPU 44 compares generation patterns of a plurality of motion vectors registered in the register RGSTgyr with each of the one or at least two predetermined motion patterns. As a result, when the generation pattern of the motion vector is coincident with any of the predetermined motion patterns, the sub CPU 44 determines that the power-on operation is not performed and does not execute the above-described transferring process (see FIG. 6 (B)).

In the register RGSTgyr, the plurality of motion vectors respectively corresponding to multiple occurrences of the motions are held, however, one or at least two motion vectors registered during no more than a period necessary for comparing patterns before a time point of registering the latest motion vector may be secured. A period during which the motion vector is secured is set to 15 seconds, for example.

Moreover, a lock switch 28b used for restricting the above-described transferring process is arranged in the key input device 28. The lock switch 28b is set to a state of locked or unlocked by an operation of the operator. When the motion vector is outputted from the gyro sensor 56, the transferring process is executed only when the lock switch 28b is in the unlocked state, and the transferring process is not executed when the lock switch 28b is in the locked state. It is noted that, when the lock switch 28b is in the locked state, supplying the power to the gyro sensor 56 may be stopped.

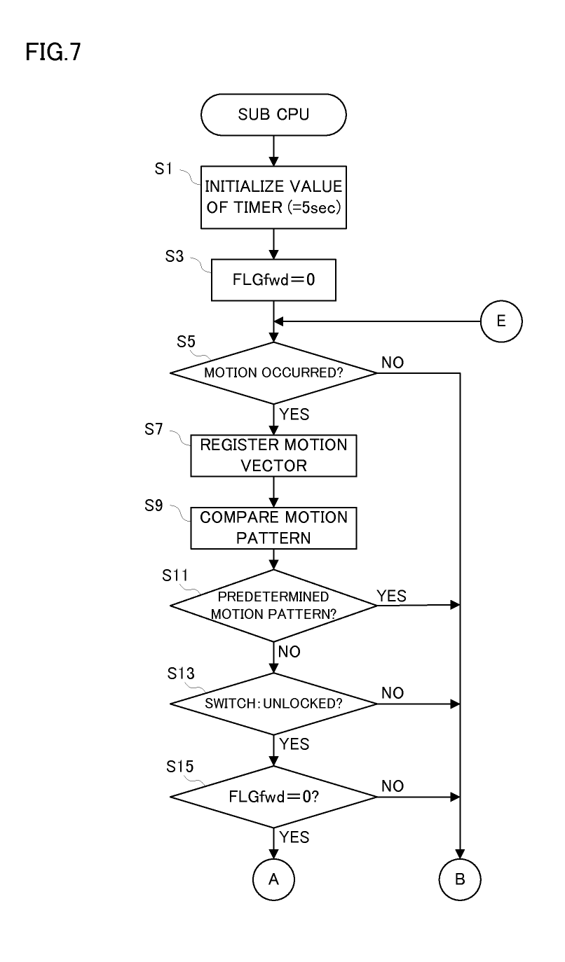

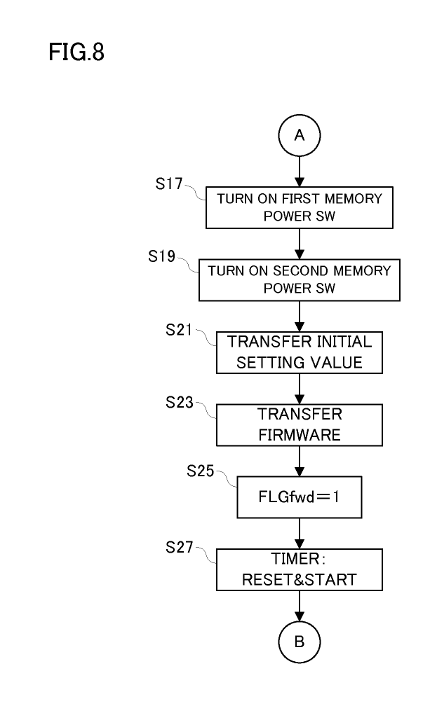

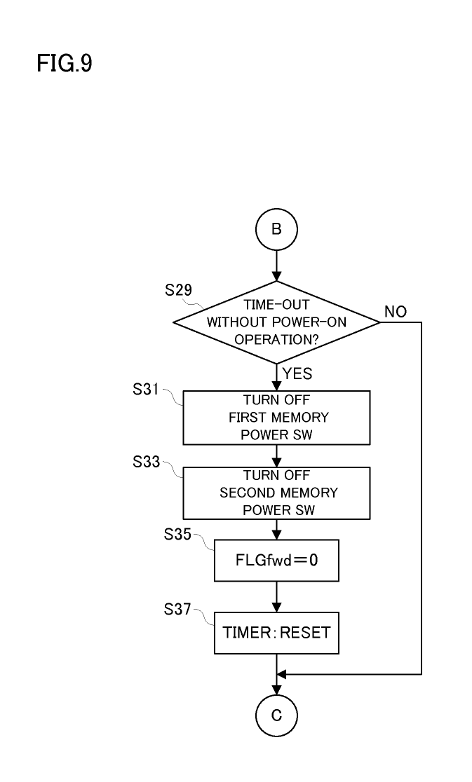

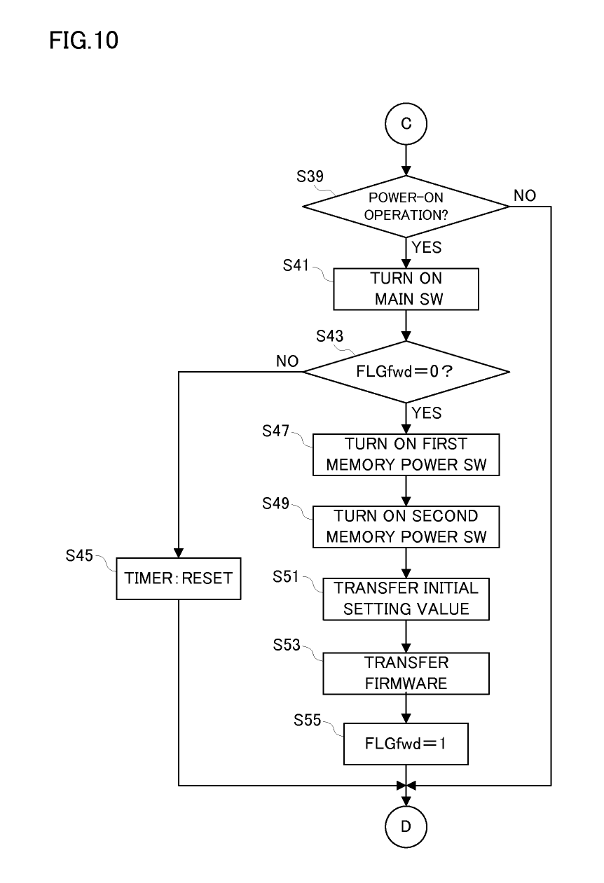

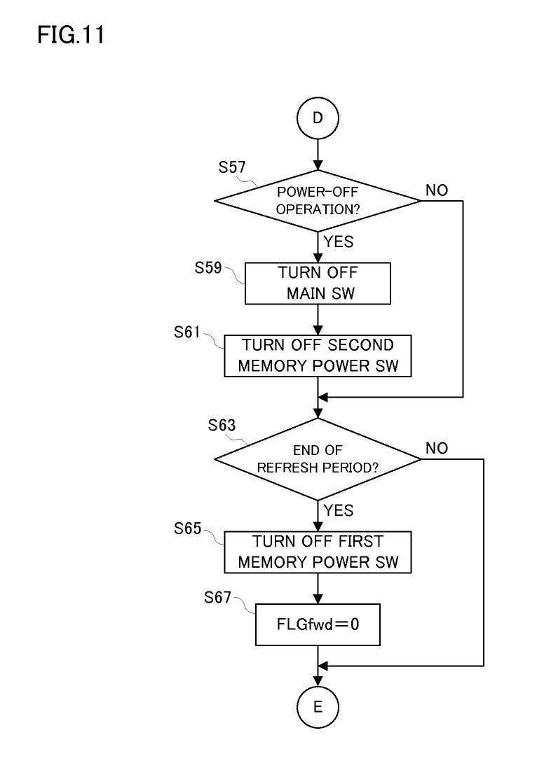

The sub CPU 44 executes processes according to flowcharts shown in FIG. 7 to FIG. 10. Moreover, the main CPU 26 executes a plurality of tasks including the main task shown in FIG. 11, in a parallel manner. It is noted that, control programs corresponding to the tasks including the main task executed in the main CPU 26 are stored in the flash memory 42, as the above-described firmware.

With reference to FIG. 7, in a step Si, a value of the timer 44t is initialized to “5 seconds”, and in a step S3, the flag FLGfwd is set to “0” as an initial setting. When the motion vector is outputted by the gyro sensor 56, in a step S5, it is determined whether or not a motion has occurred in the digital camera 10. When a determined result is NO, the process advances to a step S29 whereas when the determined result is YES, the process advances to a step S7.

In the step S7, the motion vector outputted from the gyro sensor 56 is registered in the register RGSTgyr In a step S9, generation patterns of a plurality of motion vectors registered in the register RGSTgyr are compared with each of the one or at least two predetermined motion patterns.

In a step S11, as a result of a comparing process in the step S9, it is determined whether or not the generation pattern of the motion vector is coincident with any of the predetermined motion patterns. When a determined result is YES, it is determined that the power-on operation is not performed, and the process advances to the step S29. On the other hand, when the determined result is NO, the process advances to a step S13.

In the step S13, it is determined whether or not the lock switch 28b is in the unlocked state, and when a determined result is NO, the process advances to the step S29 whereas when the determined result is YES, the process advances to a step S15. In the step S15, it is determined whether or not the flag FLGfwd is set to “0”, and when a determined result is NO, the process advances to the step S29 whereas when the determined result is YES, the process advances to a step S17.

In the step S17, the memory control circuit 30 and the SDRAM 32 are activated by controlling the first memory power switch 52, and in a step S19, the flash memory 42 is activated by controlling the second memory power switch 54.

In a step S21, the initial setting value necessary for executing the firmware of the digital camera 10 is transferred from the flash memory 42 to the SDRAM 32. In a step S23, the firmware of the digital camera 10 is transferred from the flash memory 42 to the SDRAM 32.

In a step S25, the flag FLGfwd is set to “1”, and in a step S27, resetting and starting the timer 44t is executed. In the step S29, it is determined whether or not the time-out is occurred in the timer 44t without the power-on operation being performed, and when a determined result is NO, the process advances to a step S39 whereas when the determined result is YES, the process advances to the step S39 via processes in steps S31 to S37.

In the step S31, the memory control circuit 30 and the SDRAM 32 are stopped by controlling the first memory power switch 52, and in the step S33, the flash memory 42 is stopped by controlling the second memory power switch 54. In the step S35, the flag FLGfwd is set to “0”, and in the step S37, resetting the timer 44t is executed.

In the step S39, it is determined whether or not the power-on operation is performed by the power button 28a, and when a determined result is NO, the process advances to a step S57 whereas when the determined result is YES, the main power switch 50 is turned on in a step S41.

In a step S43, it is determined whether or not the flag FLGfwd is set to “0”, and when a determined result is NO, the process advances to the step S57 via a process in a step S45 whereas when the determined result is YES, the process advances to the step S57 via processes in steps S47 to S55. In the step S45, resetting the timer 44t is executed.

In the step S47, the memory control circuit 30 and the SDRAM 32 are activated by controlling the first memory power switch 52, and in the step S49, the flash memory 42 is activated by controlling the second memory power switch 54.

In the step S51, the initial setting value necessary for executing the firmware of the digital camera 10 is transferred from the flash memory 42 to the SDRAM 32. In the step S53, the firmware of the digital camera 10 is transferred from the flash memory 42 to the SDRAM 32. In the step S55, the flag FLGfwd is set to “1”.

In the step S57, it is determined whether or not the power-off operation is performed by the power button 28a, and when a determined result is NO, the process advances to a step S63 whereas when the determined result is YES, the process advances to the step S63 via processes in steps S59 to S61.

In the steps S59 and S61, a part of the entire system except the memory control circuit 30 and the SDRAM 32 is stopped by respectively controlling the main power switch 50 and the second memory power switch 54. The SDRAM 32 starts to execute the refresh using own internal counter.

In the step S63, it is determined whether or not the period of executing the self-refresh by the SDRAM 32 has ended, and when a determined result is NO, the process returns to the step S5 whereas when the determined result is YES, the process returns to the step S5 via processes in steps S65 to S67. In the step S65, the memory control circuit 30 and the SDRAM 32 are stopped by controlling the first memory power switch 52, and in the step S67, the flag FLGfwd is set to “0”.

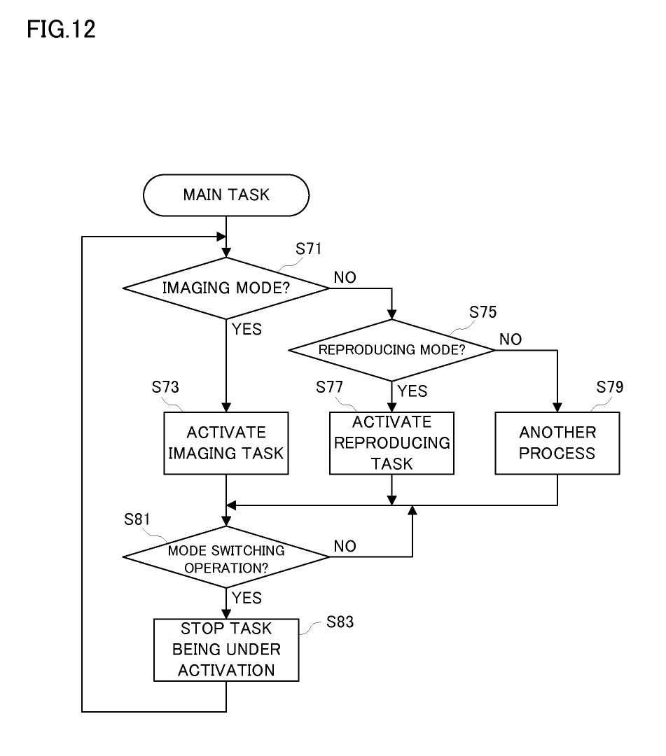

With reference to FIG. 12, in a step S71, it is determined whether or not an operation mode at a current time point is the imaging mode, and in a step S75, it is determined whether or not an operation mode at a current time point is the reproducing mode. When a determined result of the step S71 is YES, the imaging task is activated in a step S73. When a determined result of the step S75 is YES, the reproducing task is activated in a step S77. When both of the determined result of the step S71 and the determined result of the step S75 are NO, another process is executed in a step S79.

Upon completion of the process in the step S73, S77 or S79, in a step S81, it is repeatedly determined whether or not the mode changing button 28md is operated. When a determined result is updated from NO to YES, the tasks being under activation is stopped in a step S83, and thereafter, the process returns to the step S71.

As can be seen from the above-described explanation, the gyro sensor 56 detects the motion of the digital camera 10. The first memory power switch 52, the second memory power switch 54 and the sub CPU 44 supply the power to the SDRAM 32 in response to a detection of the gyro sensor 56. The sub CPU 44 loads the program executed by the main CPU 26 into the SDRAM 32, in association with the supplying process of the first memory power switch 52, the second memory power switch 54 and the sub CPU 44. The main power switch 50 and the sub CPU 44 supply the power to the main CPU 26 in response to the power-on operation after the loading process of the sub CPU 44.

When the motion is detected, the power is supplied to the internal memory, and concurrently, the program is loaded into the internal memory. Moreover, the power is supplied to the processor which executes the loaded program in response to the power-on operation after the loading process. Thus, it is not necessary to load the program when the program is thereafter executed by the processor, and as a result, it becomes possible to shorten a period until the program becomes capable of being executed. Moreover, it becomes possible to inhibit a waste of power resulting from the program processing apparatus being unnecessarily activated.

It is noted that, in this embodiment, the firmware, etc. of the digital camera 10 are transferred from the flash memory 42 to the SDRAM 32. However, the firmware, etc. of the digital camera 10 may be held in the recording medium 40 so as to transfer from the recording medium 40 to the SDRAM 32.

Moreover, in this embodiment, when the time-out is occurred in the timer 44t without the power-on operation being performed, the SDRAM 32 and the flash memory 42 are stopped. However, stopping the flash memory 42 may be executed immediately after completion of the transferring process for the firmware, etc.

Moreover, in this embodiment, the present invention is explained by using a digital still camera, however, a digital video camera, a personal computer, cell phone units, a smartphone or a digital audio player may be applied to.

Although the present invention has been described and illustrated in detail, it is clearly understood that the same is by way of illustration and example only and is not to be taken by way of limitation, the spirit and scope of the present invention being limited only by the terms of the appended claims.

1. A program processing apparatus, comprising:
a detector which detects a motion of a device;
a first supplier which supplies power to an internal memory in response to a detection of said detector;
a loader which loads a program executed by a processor into said internal memory, in association with a supplying process of said first supplier; and
a second supplier which supplies the power to said processor in response to a power-on operation after a loading process of said loader.

2. A program processing apparatus according to claim 1, further comprising a first memory power stopper which stops to supply the power to said memory when a designated period has elapsed since a timing of a loading process of said loader without the power-on operation being executed.

3. A program processing apparatus according to claim 1, further comprising a first restrictor which restricts a supplying process of said first supplier when a generation pattern of the motion detected by said detector is coincident with any one of one or at least two predetermined patterns.

4. A program processing apparatus according to claim 1, further comprising:
a processor power stopper which stops to supply the power to said processor in response to a power-off operation; and
a second memory power stopper which stops to supply the power to said internal memory when a designated period has elapsed since a timing of a stopping process of said processor power stopper.

5. A program processing apparatus according to claim 1, further comprising a second restrictor which restricts a supplying process of said first supplier in response to a supply restricting operation.

6. A program processing apparatus according to claim 1, wherein said internal memory is equivalent to a volatile memory.

7. An electronic camera, comprising a program processing apparatus according to claim 1.

8. An electronic camera according to claim 7, wherein said program is equivalent to firmware.

9. A program processing program recorded on a non-transitory recording medium in order to control a program processing apparatus, the program causing a first processor of the program processing apparatus provided with a detector which detects a motion of a device to perform the steps comprising:
a first supplying step of supplying power to an internal memory in response to a detection of said detector;
a loading step of loading a program executed by a processor into said internal memory, in association with a supplying process of said first supplying step; and
a second supplying step of supplying the power to said processor in response to a power-on operation after a loading process of said loading step.

10. A program processing method executed by a program processing apparatus provided with a detector which detects a motion of a device, comprising:
a first supplying step of supplying power to an internal memory in response to a detection of said detector;
a loading step of loading a program executed by a processor into said internal memory, in association with a supplying process of said first supplying step; and
a second supplying step of supplying the power to said processor in response to a power-on operation after a loading process of said loading step.

11. An electronic camera, comprising a program processing apparatus according to claim 2.

12. An electronic camera, comprising a program processing apparatus according to claim 3.

13. An electronic camera, comprising a program processing apparatus according to claim 4.

14. An electronic camera, comprising a program processing apparatus according to claim 5.

15. An electronic camera, comprising a program processing apparatus according to claim 6.

16. An electronic camera according to claim 11, wherein said program is equivalent to firmware.

17. An electronic camera according to claim 12, wherein said program is equivalent to firmware.

18. An electronic camera according to claim 13, wherein said program is equivalent to firmware.

19. An electronic camera according to claim 14, wherein said program is equivalent to firmware.

20. An electronic camera according to claim 15, wherein said program is equivalent to firmware.
